(19) United States
(12) Patent Application Publication
(10) Pub. No.: US 2004/0111424 A1
(43) Pub. Date: Jun. 10, 2004

(54) Data-driven web application generator and server

(76) Inventors: Kendyl A. Roman, Sunnyvale, CA (US); David Hoffman, Toronto (CA); Paul Raposo, San Francisco, CA (US)

Correspondence Address: Kendyl A. Roman, 730 Bantry Court, Sunnyvale, CA, 94087, US

(21) Appl. No.: 10/646,991

(22) Filed: Aug. 21, 2003

Related U.S. Application Data
(60) Provisional application No. 60/405,694, filed on Aug. 21, 2002.

(51) Int. Cl. G06F 7/00

(52) U.S. Cl. 707/100

(57) ABSTRACT

A system that reduces the time and cost of developing and maintaining a robust, scalable, secure, high performance web site that has a common look and feel and functionality that meets user requirements and takes full advantage of the underlying database management system. The system includes a toolkit, a code generator, and optional documentation generators. The toolkit comprises programs that can be stored in the database. The programs in the toolkit can be grouped into three categories: 1) core programs, 2) interface programs, and 3) application programs. The application programs reference the interface programs to generate dynamic web pages that have a common look and feel, can be customized for specific users, and automatically interface with both convention web browsers and compact mobile devices. The core programs provide robust functionality needed by high-end commerce sites. The application programs provide the customized functionality to display information from the database and to query the user for search criteria and data entry. Application programs are generated with a code generator that takes input from initialization files. Database tables, for both user data and system operation data, are created from scripts that are also used by documentation generators. The documentation generators produce accurate and timely documentation of the design details of the system.

### RELATED APPLICATION

This application claims priority under 35 U.S.C. § 119(e) of the U.S. provisional application Serial No. 60/405,694 filed on 2002 Aug. 21, and entitled “DATA-DRIVEN WEB APPLICATION GENERATOR AND SERVER.”

### BACKGROUND

1. Field of the Invention

This invention relates to a system for generating and serving data-driven web applications.

2. Description of Prior Art

There has been unprecedented development and growth in world-wide use of the Internet. Specifically, the Internet information space known as the World Wide Web has become significant tool for communications, commerce, research, and education. Almost every major business or organization and many individuals have created web sites. Web sites are integrated with database management systems to provide access to large databases and to store transactions and other critical or dynamic information. It is not uncommon for the development of a web site that interfaces with a database to cost millions of dollars.

In the past, artists and web designers have designed the look and feel of a web site. They have created each page of the web site one page at a time. If new features need to be added, every page must be redesigned or rewritten.

Independently, programmers have provided rudimentary access to the database through generic interfaces such as Open Database Connectivity (ODBC), Java Database Connectivity (JDBC), Active Server Pages (ASP), Java Server (JSP), JavaScript, and perl. This simple access method only provide a limited set of features and fail to take advantage of the powerful native features of a robust database management system such as Oracle, Sybase, DB2, SQL Server, or similar database systems.

The Oracle database and web server software has enjoyed a reputation in the industry as one of the leading development platforms for both database and web site development. The Oracle web toolset provides a very robust, scalable, secure technology platform, yielding high performance applications used by many companies to support their mission critical information applications.

The Oracle solution is neither the cheapest nor the simplest. It, in fact, requires a greater up-front investment in the technology (high license costs) and highly skilled developers to bring the final applications to a production state.

The Oracle database is a robust tool that does not constrain the developer. It also offers a suite of tools specifically designed for various purposes. These tools, such as Developer2000, a forms based development tool, supply a framework for rapid application development. However, these tools do not exist for web-based applications. Because of this fact, no framework is provided to guide and speed development. System features such as a consistent interface look-and-feel, consistent internal architecture, consistent programming and naming conventions and an existing framework of modules to support development must first be designed and engineered to facilitate development. This is very time consuming.

There is a need for a system that reduces the cost of developing and maintaining a robust, scalable, secure, high performance web site that has a common look and feel and functionality that meets user requirements and takes full advantage of the underlying database management system.

### SUMMARY OF THE INVENTION

Accordingly, it is an objective of the present invention to provide a system that reduces the cost of developing and maintaining a robust, scalable, secure, high performance web site that has a common look and feel and functionality that meets user requirements and takes full advantage of the underlying database management system. The system includes a toolkit, a code generator, and optional documentation generators. The toolkit comprises programs that can be stored in the database. These programs are sometimes referred to as stored procedures or packages. The programs in the toolkit can be grouped into three categories: 1) core programs, 2) interface programs, and 3) application programs. The application programs reference the interface programs to generate dynamic web pages that have a common look and feel, can be customized for specific users, and automatically interface with both convention web browsers and compact mobile devices. The core programs provide a foundation for robust functionality needed by high-end commerce sites. The application programs provide the customized functionality to display information from the database and to query the user for search criteria and data entry. Application programs are generated with a code generator that takes input from code definition files. Database tables, for both user data and system operation data, are created by scripts that are also used by the documentation generators to produce documentation. The documentation generators produce documentation of the design details of the system.

### OBJECTS AND ADVANTAGES

Accordingly, beside the objects and advantages described above, some additional objects and advantages of the present invention are:

1. To reduce the cost of developing a database enabled web site.

2. To improve performance of a large web site.

3. To provide for scalability of a web site as it becomes more successful and larger without costly re-architecture.

4. To provide a common, easily modified look and feel for all web pages.

5. To provide web pages customized for specific users.

6. To provide a secure, cookie-less session, web site.

7. To provide an integrated site for interfacing with both convention Web browsers and compact, mobile devices.

8. To provide support for HTML, Java, JavaScript, Flash, Style Sheets, and other robust web site components.

9. To provide a number of pre-defined objects which perform a variety of complex functions, and which can be easily customized.

10. To provide a code generator that ensures a consistent internal architecture.

11. To provide documentation generators.

12. To provide for rapid application development of complex web applications.

13. To provide a set of robust, commonly needed functions and features.

14. To provide up to date, accurate documentation for a data-driven web application database.

15. To reduce costs of debugging and maintaining a complex data enabled web site.

These and other features and advantages of the present invention will become apparent upon consideration of the following specification, claims [omitted], and drawings.

### DRAWING FIGURES

In the drawings, closely related figures have the same number but different alphabetic suffixes.

FIG. 1 shows the central components of the system.

FIG. 2 shows a high level view of the system.

FIG. 3 shows details an embodiment of the toolkit.

### REFERENCE NUMERALS IN DRAWINGS

| | |
|---|---|
| 100 | toolkit |
| 110 | core programs |
| 120 | interface programs |
| 130 | application programs |
| 140 | data tables |
| 145 | data interfaces |
| 150 | database |
| 160 | code definition files |
| 162 | code generator input |
| 170 | code generator |
| 180 | data definition files |
| 182 | documentation generator input |
| 184 | database definition script190 |
| | documentation generators |
| 195 | documentation |
| 200 | project team |
| 202 | business team |
| 204 | artists and designers |
| 206 | development methodology |
| 208 | development team |
| 210 | business direction |
| 212 | analysis and design |
| 214 | artistic direction and design |
| 215 | RAD tools |
| 216 | artisitic direction |
| 218 | static graphics |
| 220 | image files |
| 222 | file system |
| 224 | document definition file |
| 226 | layout design |
| 228 | generated code |
| 230 | DBMS web toolkit |
| 232 | data retrieval |
| 234 | data storage |
| 240 | web server |
| 242 | server request |
| 244 | toolkit response |
| 246 | file access |
| 248 | toolkit request |
| 250 | network |
| 252 | testing |
| 260 | web site users |
| 262 | web browsing device |
| 264 | user |
| 266 | browser request |
| 268 | server response |
| 270 | operations |
| 272 | server computers |
| 274 | operators |
| 276 | physical storage |
| 280 | web site |
| 290 | web hosting |
| 299 | project |
| 300 | document customization |
| 310 | data design customization |
| 320 | application customization |
| 330 | code design customization |
| 340 | code generation customization |
| 350 | core reference |
| 360 | interface reference |

### DESCRIPTION OF THE INVENTION

The present invention comprises a system that reduces the cost of developing and maintaining a robust, scalable, secure, high performance web site that has a common look and feel and functionality that meets user requirements and takes full advantage of the underlying database management system.

In order to facilitate development in the complex database environment, a web development toolkit provides the developer with the ability to rapidly design and deploy conventional HTML and WAP (or other mobile) web sites. Included is support for technologies such as Java, JavaScript, Flash and a host of other web-based technologies. The system of the present invention can be used to develop any web site application for any business or organization that will run on any browser and wireless phone or mobile PDA. Its design and framework provide the ideal platform for custom web sites that can be rapidly prototyped and developed. Using the toolkit to prototype and develop typically requires a small fraction of the time and cost as compared to developing for the same web environment without the toolkit. The reason is because the toolkit comes complete with an initial working database model (that manages those functions common to most web sites) and the web site user interface pages including graphics, code and pre-programmed modules that can be used as is or customized. They are included in the project and are fully functional.

An embodiment of toolkit was initially developed against and currently works with the Oracle database. The present invention, however, can be with any other databases that support in a web-based environment.

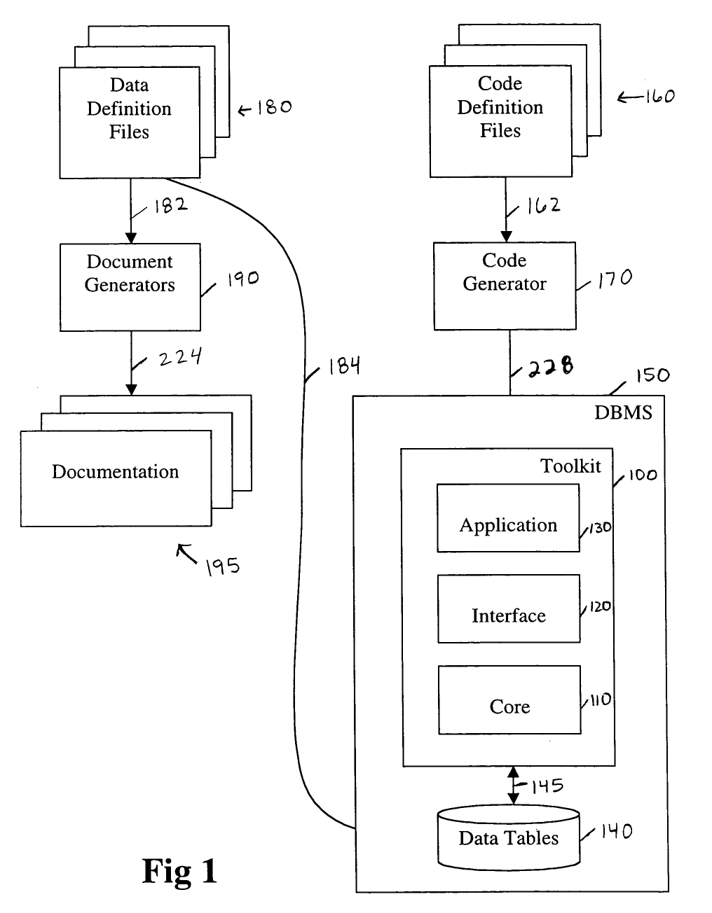

FIG. 1

FIG. 1 illustrates the central components of the system.

In this exemplary embodiment, a fully functional web site is provided by a customizable toolkit 100. The toolkit is comprised of database programs also known as stored procedures or packages. The database programs typically are written in one or more languages supported by the database vendor. Oracle, for example, supports its proprietary PL/SQL language as well as Java, perl, and other languages. PL/SQL is preferred because of it is closely tied with Oracle database and provides superior power and performance. For other embodiments with other database management systems, another suitable language can be used. The toolkit programs are organized into three parts:

Core programs 110

Interface programs 120

Application programs 130

The database management system (DBMS) referred to here as the database 150 contains the data tables 140 and the toolkit 100. The data interfaces 145 provide a way for toolkit programs to be data driven.

The toolkit provides an Application Programmers Interface (API) and a framework upon which to build a robust web site. The framework can be used as-is if only default functionality is needed. Typically however application specific customization is necessary. The system of the present invention provides for rapid customization of the framework and toolkit programs to produce robust web applications.

The core programs 110 transcend any web site implementation and provide that part of the framework that is the foundation upon which the other toolkit programs are built. For this reason the development team rarely will need to modify this code.

The interface programs 120 relate to the look and feel for the entire web site. These manage the overall web site look as well as page/form components that comprise every page body and menu in the web site. The interface supports conventional HTML based pages as well as other formats that support mobile and wireless devices, such as Wireless Application Protocol (WAP), Scalable Vector Graphics (SVG), etc. This part of the toolkit isolates the application programs 130 for having to deal with the details of page layout, screen sizes, etc.

The application programs 130 (collectively known as the web application) relate to each function that will be run on the web site. These functions defer to the interface layer for presentation on the web site.

To facilitate the rapid customization of the toolkit, several toolkit programs are not coded directly by programs. Instead, a code generator 170 creates these toolkit programs. The programmer defines the program functions in code definition files 160. The code definition files 160 become the code generator input 162. The output of the code generator is toolkit programs, which conform to the API. This generated code 228 is in an appropriate language such as Oracle's PL/SQL as discussed above. A single code generator could be implemented to produce multiple versions of an application. Alternatively, multiple code generators could be implemented so that each would produce output in a single application version.

To facilitate the rapid customization of the data tables and documentation, the database programmer defines the data in data definition files 180. The data definition files are document generator input 182. One or more documentation generators 190 process these files to produce one or more document definition files 224. A single documentation generator could be implemented to produce output of different formats. Alternatively, multiple documentation generators could be implemented so that each would produce output in a single format. The document definition file(s) 224 can be read by a documentation application to produce a fully formatted, and optionally indexed, set of documentation for the project. The documents produced include detailed entity-relationship and attribute documents and documentation on the code functions. Good results have been obtained by generating MIF files for Adobe FrameMaker and Rich Text Format (RTF) for Microsoft Word. The same data definition files 180 are processed by the database 150 to create the data tables. Thus by changing the data definition tables both the data tables 140 and the documentation files 195 can be efficiently modified and kept up to date.

The toolkit contains pre-packaged objects/modules required by most web sites that can serve as the base web site version. The base includes database and code objects. The default modules can be customized for desired functionality or can be removed if the function they provide is not needed.

The toolkit design and framework architecture allows the development team's focus to remain on the analysis and design rather than the coding because the architecture deals with many issues facing web site developers. Also, built into the design is the provision to customize virtually every aspect of the base framework.

In summary, a rapid application development (RAD) system, such as this, can be employed to significantly reduce the design and development time required to produce the web site. The system works with two components. The first component is a set of pre-packaged, pre-programmed objects/modules, which, in general, are required by most web sites (toolkit 100). The second component is a form generator (code generator 170) that is used to create custom web pages for the remaining objects for a specific web site application. This component is facilitated by a template driven architecture; ensuring ease of development, ease of debugging, consistent site-wide look and feel and fully tested working code.

Many of the features required by any web site are similar. The toolkit has modularized these features for a couple reasons: First, to provide an actual visual of the web site. Second, the modules serve as a default, working prototype that illustrate how they work. They can be left as-is, customized, or removed.

The modules supplied with the toolkit 100 address: managing user accounts (registration and roles), secure access to the web site and the users private data (login), ‘cookieless’ sessions when a user is logged in (most websites require cookies to sustain a page after page session), dynamic menus, access to web site services (functions and privileges), contacting the company or other users of the web site (e-mail and inter-user messaging), site bulletins, e-commerce (store-front, shopping cart, invoice, and credit card payment processing) and a host of administrative tools to allow the web site to be managed. This toolset addresses these requirements by including a complete set of pre-designed, pre-programmed objects/modules that provide this functionality.

The code generator 170 uses the output of the business analysis project phase as input to create the application specific custom web pages. These web pages share the same consistent internal architecture and provide the mechanism that allows data to be stored, viewed, modified and deleted from the database. Once generated, these web pages can be customized (if required) in a matter of minutes or hours.

Data Driven

The system of the present invention is data driven at two levels.

At the first level, web pages on the web site are not static, every access to the web site allows the web site to generate a dynamic page based on data in the database. For example, if a 13-year old girl logs on to the web site, the pages can be displayed in pastel colors and can contain features of interest to that user. The same page can be displayed in masculine colors for a 40-year old man. Also a parent may be granted more privileges than a child. A web site administrator may be granted more privileges than a normal user. The menus will only contain options that are appropriate for the particular privilege level.

At the second level, the data tables 140 and the toolkit 100 programs are data driven in that they are generated based on the data definition files 180 and the code definition files 160. As discussed above, these data-driven characteristics provide many of the benefits of the present invention.

System Development Methodology

As mentioned previously, the toolkit 100 is a tool to facilitate rapid web site development. It is no way regulates or dictates what analysis, design and coding methodologies should be used. It provides a set of tools that can be used in conjunction with many methodologies. Details of a preferred development methodology is described in Appendix A, entitled System Development Methodology.

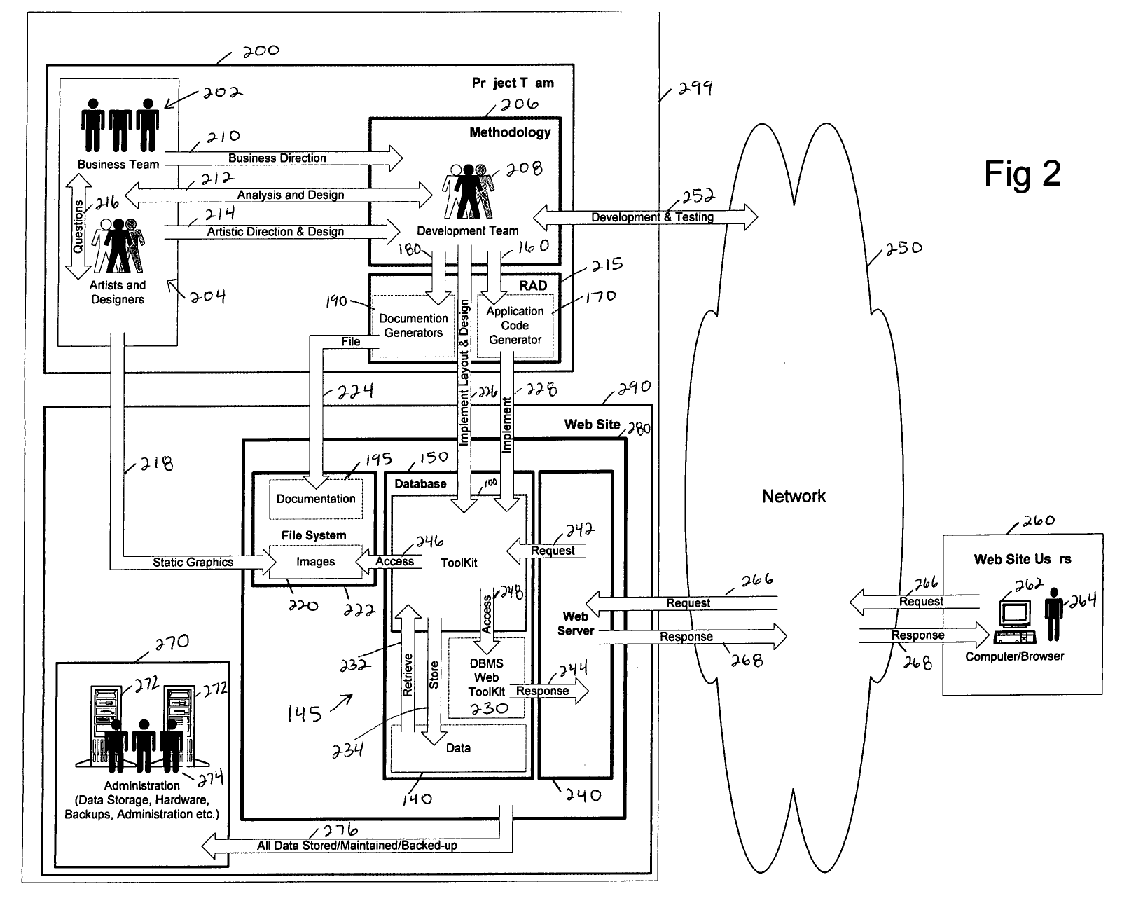

FIG. 2

FIG. 2 illustrates a high level view of an embodiment of the system of the present invention.

Part of our methodology 206 dictates that a project team 200 be assembled. This team is responsible for the analysis and design all the way through project from implementation to completion of the web site. They have ownership, if you will. The project team 200 is best comprised of a business team 202, artists and designers 204, a development team 206. The business team 202 typically includes project management, domain experts, marketing and sales specialists, who collectively provide the development team with business direction 210. The artists and designers 204 provide the development team with artistic direction and design 214 including web page style guidelines. The artists and designers 204 work with the business team 202 to determine the artistic direction 216 by asking and answer business questions. As part of rapid application development methodology 206, the project team 200 works together to accomplish the iterative process of analysis and design 212. The development team uses the RAD tools 215 which include the code generator 170 and the documentation generators to develop rapid prototypes that can be reviewed by the other members of the project team 200.

The traditional project phases include the Business Analysis Phase, the System Analysis Phase, the Design Phase, the Construction Phase, the Testing Phase, the Implementation Phase, the Production Phase and the Post Implementation Review Phase. These phases remain the same in the preferred methodology 206. As mentioned above the system of the present invention is not limited by a specific methodology.

Development of any web site or application assumes that the development team has first completed the Business Analysis Phase, the System Analysis Phase and the Design Phase. There are several steps that will need to be taken and tasks that need to be accomplished. These are not necessarily in any order:

1) The above phases should produce the following documents:

a) Entity-Relationship (ER) Model or Logical Model

b) Physical or Database Model

c) Functional Specification, which is used to determine what functions are required.

2) Artists and designers 204 create web site look. Each interface module must be considered and changed by the development team 208 if required.

a) Project Team 206 must decide on web site look and feel.

b) Development team 208 applies the design into the interface portion of toolkit (layout design 226)

c) Development team 208 applies the design (if necessary) into the application portion of the toolkit to accommodate changes/additions/deletions to the interface portion of the toolkit (generated code 228 or layout design 226).

d) Artists 204 create all required media in the form of static graphics 218.

e) Development team 208 post media for web site use as image files 220 in the file system 222.

3) Physical or Database Model

a) Used as input into the documentation generators 190 for generation of the design documentation 195. The documentation 195 is stored in the file system. The project team 200 must review the documentation.

b) Used to create database tables that conform to the overall design.

4) Functional Specification

a) Used as input to define code definition files 160, which are then used as input into code generator 170 to generate the web application pages of the project. One code definition file 160 is created for each web site entity/function. The generated web application pages can be customized, if required.

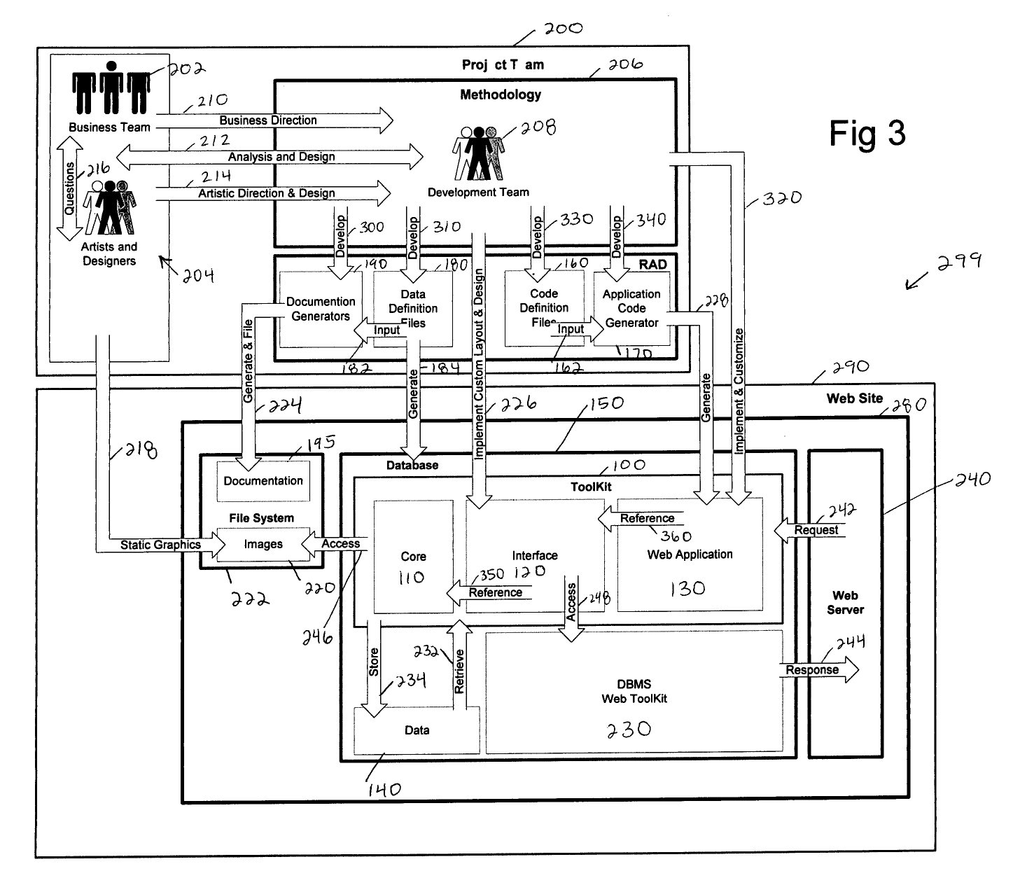

b) Functions that don't fit the code generator model can be customized or manually developed to use the same toolkit/generator architecture or API (see application customization 320 in reference to FIG. 3 below).

The system yields an easy implementation of a consistent look and feel by having the page, fonts, etc. defined in a single place. The look and feel is easily defined at the beginning of a new project. If changes are desired, changes take only hours to make after a new web design has been implemented.

The system includes a number of existing object modules that perform a variety of complex functions typically found in any web application. These include:

User registration/membership,

User roles,

Secure access to the application, login and “forgot my password” services,

Sessions without the use of cookies,

Functions and privileges,

Dynamic menus (based on user role, logged in, logged out), including bulletin and message notification,

Administrative tools to allow for web site management

Site-wide bulletins and broadcasts,

Inter user messaging,

E-mail,

Writing files to disk,

E-commerce functions that include a store, shopping cart, invoicing, checkout, credit card payment processing and receipts.

The system of the present invention is designed for use with a robust, industrial strength database. Oracle, for example, is portable to many platforms. This means that development could happen on an NT machine and then ported to a Sun machine. This could be done in minutes providing significant, low-cost scalability.

System Operation

The system operation can be explained with further reference to FIG. 2. The toolkit 100 is designed to interface with DBMS web toolkit 230 which is part of the database 150. In the preferred embodiment, Oracle 9i provides the features of the DBMS web toolkit 230. The web toolkit 230 provides an interface to a web server 240. Oracle provides support for Oracle Application Server and Oracle Internet Server. Other web server software such as Apache, Netscape, iPlanet, and Microsoft IIS could also be used. The web site 280 is comprised of the database 150, the file system 222, and the web server 240.

The website is physically hosted by operations 270. Operations provide server computers 272. Typically more that one computer will be used to host the web server 240, the database 150, the data tables 140 of the database, and the file system 222. This is usually transparent to the user who sees one logical system. The physical storage of the logical web site is represented by the physical storage 276 path showing the web hosting 290 function. The operators 274 provide database administration including data storage, hardware maintenance, backups, and continuing maintenance of the production system.

The project 299 is comprised of the project team 200 and the web hosting 290 entity.

The website is connected to a network 250. Typically the network is the public Internet, but could be a private network, intranet, or some other network. The web site users 260 are connected to the web site 280 via the network. Each web site user has a web browsing device 262 and a user 264. Examples of web browsing devices 262 are person computers running conventional web browses such as Netscape Navigator or Microsoft Internet Explorer, Palm OS based PDAs with WAP browsers, cellular phones with mobile web browsers, etc.

The user 264 begins a transaction by entering a uniform resource locator (URL) in a web browser. If the URL references the web site 280 of the present invention, a browser request 266 is passed through the network 250 to the web server 240. The web server 240 translates the browser request 266 into a server request 242 to the toolkit 100. The toolkit 100 programs handle the server request 242. In some cases, the toolkit 100 will:

access the data tables 140 to retrieve specified data (data retrieval 232),

access the data tables 140 to store input data (data storage 234),

access the file system 222 to retrieve an image file 220 (file access 246)

Note that the data interfaces 145 include data retrieval 232 and data storage 234.

The toolkit 100 will then make toolkit requests 248 to build a toolkit response 244 page. The web toolkit 230 will pass the response page to the web server 240 which in turn will relay the page as a server response 268 via the network 250 to the user's web browsing device 262.

When testing 252 the web site 290, the development team 208, accesses the test version of the web site 280 through a secure network connection. Because the toolkit 100 is stored in the database 150, multiple versions of the system can exist on the same web server 240.

FIG. 3

FIG. 3 shows detail of the use of the system in an Oracle embodiment. The code generation, and data table and document generation can be understood further by reference to FIG. 3.

Code Generation

Code generation is accomplished in two parts. First, a “standardized web page” (or package), to be used by every Web Application page (package) on the web site, is designed. Second, the code generator 170 generates all of the Web Application pages (packages) for a specific web site. The generated pages conform to the pre-defined “standardized web page”.

The system provides a default set of programs that provide the end user of the web site with ability to:

Enter query criteria to select a set of records,

View a list of existing records,

View the details of a single record,

Perform data manipulation on the data in the database. This includes inserting new records and updating and deleting existing records.

In addition, the system provides the development team 208 with standardized internal architecture for every application page in the entire web site. This means that once a developer is familiar with one of the application page, he is familiar with all the application pages since they all have the same internal architecture:

Development of any web site assumes that the developer has first completed a standard business analysis phase (see Appendix A, Development Methodology for details). One of the outputs of the business analysis phase is the Entity-Relationship (ER) model, which is required as input for the toolkit.

Getting from the ER model to the functioning application package is a two-step process. First the developer must create a code definition file 160. This file is used as input to the code generator 170, which, in the Oracle embodiment, produces “standardized” Oracle PL/SQL source code. This source code is then compiled in the Oracle environment to create a PL/SQL package, or the final application page the end user will see. In other embodiments with other database management systems, such as Sybase, DB2, SQL Server, Informix, ingress, Progress, etc., the web page program should be implemented in an language with similar capabilities, if available.

The system relies upon an existing framework or architecture of the modules that make up the web site. Each PL/SQL package generated by system will fully integrate with and function correctly in the pre-defined web site architecture.

The internal architecture is divided into three distinct layers. These are:

core 110 layer

interface 120 layer

application 130 layer

The core 110 layer is lowest layer of toolkit 100. It is a stable static layer. It should not need to be changed or require customization to function. The core 110 layer can be extended to support new features that can be included for use in the web site.

The interface 120 layer is the middle layer and references only the lower core 110 layer. The visual routines that are used by the entire web site are contained in this layer. It is in this layer where the development team 208 must make changes in order to customize the web site to support a new layout or page design (look-and-feel) or add database functionality. Alternatively, this layer can be left as-is, using the default settings, and no visual changes will occur and the standardized database functionality will remain. In addition, any new custom layouts can be added to the library of supplied layouts for future use.

The application 130 layer is the highest layer in the toolkit 100. This layer will contain all the packages that support each entity in the data model. Each entity in the data model may have a package defined to manage its data. Packages in this layer will reference interface 120 and core 110 level packages. This standardizes the look-and-feel of the web site because each package in the application 130 layer will utilize the same display mechanism.

The toolkit 100 contains some application 130 packages already created and in an executable form, completely configured into the menu system and usable. These pre-defined packages (and their corresponding code definition files) support the generic pre-defined component of the system; features such as Login, Registration, Function and Access management, Role definition and Menu management, Shopping cart, Invoice, Payment processing, Bulletins, Messages etc.

Generally, each and every application 130 package is generated by the code generator 170, and therefore share the same internal architecture. This makes it simple for the development team to understand each of the many application 130 packages in the web site because each package is formatted the same and delivers the same functionality, just for different entities.

Before any application 130 package is generated, the functionality provided to the end user must first be determined. By default, the toolkit 100 provides the user with Query, List and Detail views of the data and with database support for Insert, Update and Delete functions. These functions can be changed or amended to support new features. Any changes must also be reflected in the code generator so that all generated application 130 packages contain the same features.

Each application page generated by system may be customized (application customization 320).

Each application 130 page must be integrated into the application as whole. This is done by defining it as a function, including the function in the menu system of the application and granting access to it to a specific role.

Another output of the business analysis phase is the definition of the database objects required to support the ER model. One group of these objects make up the data tables 140 required to store the data for the application. These data definition files 180 not only contains the definition of the columns of each table, but also includes the definition of each table's referential integrity constraints and indexes. Specially formatted comments in this definition file (see the example below) are used by the documentation generators 190 to generate a standardized System Design document.

Code Generation Operation

The input to the code generator 170 of system is the code definition file 160. This file directs code generator 170 to generate an application 130 page that refers to the correct database objects (table, view, columns, etc.) and includes the specified functionality.

Typically, generating the working application 130 package is a two step process.

First, the developer creates a code definition file 160 that directs the code generator 170 to generate, in the Oracle embodiment, an Oracle PL/SQL source code file.

Second, the Oracle PL/SQL source code must be compiled into an Oracle package. This can be done using SQL*Plus.

The newly created Oracle package can now be integrated into the application.

Each application 130 package may be integrated into the application to be accessible to the end user of the application. After compilation, this is achieved by:

Defining the application 130 package as a function in the system

Including the function in the menu of the system

Granting access to the function to a specific role or roles.

At this point, any user that has been granted the privilege to the same role will see the new function appear on his menu.

Documentation Generation

The documentation generator 190 is a program that generates a design document for a given data model. This includes entities, attributes, relationships, delete rules, etc. In the preferred embodiment, the document definition file 224 is in FrameMaker format for use with Adobe FrameMaker. The style of the FrameMaker document is defined by a template. This template can be replaced or changed as long as the paragraph tag names remain the same. Alternatively, the document generator can generate a document formatted in Microsoft's Rich Text Format for use with Microsoft Word, or any similar documentation format.

At this point in the process, the Business Analysis Phase and the System Analysis Phase have been performed and are complete and that an ER Model or Logical Model and a Physical or Database Model have been scripted. The physical model must conform to a standardized create table format. Of course in this embodiment, the create table format is the Oracle create table format. This table create script is used as input into the documentation generators 190. Errors are reported if the input is not in the proper format.

Customization

FIG. 3 shows the various ways that the development team 208 can modify the default system.

Typically, the resulting web site is customized by modifying the data definition files 180 (data design customization 310) and by modifying the code definition files 160 (code design customization 330). The format to the documentation 195 can be modified by changing the documentation style template or the documentation generators 190 (document customization 300). The application code can be modified by changing the code generator 170 (code generation customization 340). If the necessary changes are beyond the scope of the code generation model, the application programs 130 can be modified directly (application customization 320).

Internal Operation

FIG. 3 also shows the internal operation of the toolkit 100. When the toolkit 100 receives a server request 242, it is handled by a specific application 130 package for that web page. The application 130 package contains the logic to process the request. The application 130 layer references the interface 120 layer via an interface reference 360. The interface 120 layer provides the look and feel for the specific web browser device 262 and specific logged in user 264 (see FIG. 2). As necessary, it accesses the core 110 layer to store and retrieve data from the data tables 140 or to retrieve image files 220. The interface 120 then formats the necessary display data, form elements, or images by making appropriate calls (toolkit requests 248) to the web toolkit 230. The web toolkit 230 passed the generated response page back to the user 264 (see FIG. 2) via the web server 240 as explained above.

### ADVANTAGES

Less Complex

The present invention takes much of complexity out of creating a complex, robust database enabled web site.

Rapid Prototyping

The present invention provides a system that can be rapidly modified reducing development cost and providing quicker more time testing and feedback during the design evaluation cycles.

Reduced Cost

The present invention reduces the cost of developing a web site, by providing a set of predefined functionality, by providing a means of rapid prototyping, and by providing easy consistent changes.

Performance

The present invention allows a web site to be quickly ported to higher performing hardware and operating systems. The tight coupling with the database 150 provides for optimum performance.

Scalable

The present invention allows a web site to be grown to meet unexpected demand without having to re-architect the web site.

Robust Feature Set

The present invention provides a set of default features that can be easily customized to meet special needs. Support for HTML, Java, JavaScript, Flash, and style sheets are included. Pre-defined objects provide commonly needed features.

Consistent Look and Feel, and Operation

The present invention facilitates a consistent look and feel and operation that provides a positive, professional user experience. The look and feel can be easily changed to meet market changes and to present an “always-fresh” appearance.

User Specific

The present invention provides each user an interface that is based on their unique interests or role.

Secure

The present invention provides a secure environment without being intrusive of the user's computer.

Automatic Layout for Conventional and Mobile Browsers

The present invention provides automatic layout for both conventional and mobile browsers.

Documentation

The present invention provides automatic formatting and indexing for design documents increasing the quality of the design and accuracy of the documents.

Easier Debugging

The present invention provides a consistent internal architecture with substantial code sharing so that it is easier to detect, isolate, and fix defects in the programs.

### CONCLUSION, RAMIFICATION, AND SCOPE

Accordingly, the reader will see that the present invention provides a system that reduces the cost of developing and maintaining a robust, scalable, secure, high performance web site that has a common look and feel and functionality that meets user requirements and takes full advantage of the underlying database management system.

While the above descriptions contain several specifics these should not be construed as limitations on the scope of the invention, but rather as examples of some of the preferred embodiments thereof. Many other variations are possible. For example other embodiments of the system can be implemented in any database management system. The documentation generator can also be implemented to support various documentation tools.

Accordingly, the scope of the invention should be determined not by the embodiments illustrated, but by the appended claims and their legal equivalents.

We claim:

1. A system for developing and maintaining a network based application wherein said application has a common look and feel, said system comprising:
a. a database comprising data tables and storage,
b. a code generator interfacing with said database,
c. toolkit programs, stored in said database, comprising:
i. an application layer,
ii. an interface layer, and
iii. a core layer
d. code definition files providing input to the code generator,
e. data definition files for defining said data tables,
wherein said code generator generates code for said application by processing code definition files,
wherein said data definition files configure said data tables to support said toolkit and said application,
wherein said data tables comprise user data and operational data for said system,
whereby the operation of a plurality of portions of said application can modified by making a single modification to said code definition files.

2. The system of claim 1, further comprising at least one document generator,
wherein said document generator generates documentation of the design details of the system in at least one document format.

3. The system of claim 1, wherein said network is the Internet.

4. The system of claim 3, further comprising:
a. a web site, connected to the Internet, comprising:
i. a web server in communication with said toolkit,
ii. a file system in communication with said toolkit,
b. at least one remote web browser running on a web browsing device connected to the Internet,
wherein said system generates dynamic web pages base on data and programs stored in said database,
whereby a user can interact with said application and view said web pages.

5. The system of claim 4, further comprising a second web browser being viewed by a second user,
wherein said web pages can be customized for specific users, such that the dynamic web page generated for the first user is different than the dynamic web page generated fro the second user.

6. The system of claim 4, wherein the system generates web pages for a plurality of formats.

7. The system of claim 6, wherein said format is for a conventional web browser.

8. The system of claim 6 wherein said format is for a mobile device, such as a mobile phone or personal digital assistant.

9. The system of claim 4 further comprising a predetermined set of code definition files and data definition files,
wherein said set of definition files provides a fully functional web site, comprising:
a. default data tables,
b. user interface pages,
c. graphics,
d. toolkit programs providing commonly needed features, such as user accounts, password management, web site administration, billing, and security,
whereby a substantially robust web site application is provided without modification of said definition files.

10. The system of claim 9 wherein said predetermined set of files provides a working example of how to generate an application such as said robust website application, wherein said working example provides a starting point for developing a substantially different application by modification of said definition files.

11. The system of claim 1 wherein said code generator, said data database, and the interface and operation of said application can be customized by modifying said code definition files and data definition files.

12. The system of claim 1 wherein said database contains the structure for said data tables and the data stored in said tables.

13. The system of claim 1 wherein one of said application layer, said interface layer, and said core layer can be changed without changing the remaining two layers, whereby such change results in a difference in said application.

14. The system of claim 13 wherein said interface layer defines a plurality of looks and feels whereby one look and feel can be changed though out the entire application without changing the remaining looks and feels and without changing the application layer.

15. The system of claim 14, wherein different formats are generated by the toolkit for display on different web browsing devices, whereby one said change results in changing the look and feel of what is displayed on a plurality of web browsing devices.

16. The system of claim 15, wherein one of said plurality of web browsing devices support the WAP format.

17. The system of claim 13 wherein said application layer defines the operation of the application, whereby changing the application layer results in a different functional application.

18. The system of claim 13 wherein said database contains a plurality of customizations that result in a plurality of substantially different applications, and wherein the core layer defines the operation of the system itself, whereby changing the core layer results in providing system wide functionalities that affect all applications.

19. The system of claim 18, further comprising at least one Internet server configured for hosting a substantially large number of applications, wherein said server is operated by an Internet Service Provider providing services to a plurality of application owners, whereby each of said application owners share a common application or core layer and is provided a custom look and feel for their specific application by customization of the data in the database that affects the interface.

20. In a system comprising of a web server, a database, a toolkit, and an application code generator,
a method of producing custom web sites with substantially different looks and operations for diverse business disciplines comprising the steps of:
a. defining data in data definition files,
b. specifying code in code definition files,
c. generating data tables based on said data definition files,
d. generating code based on said code definition files,
e. storing said generated code in said database along with said toolkit, and
f. modifying data stored in said database associated with at least one of said web sites,
whereby said system will dynamically generate web pages for at least one of said websites having a substantially different look or operation than at least one other of said websites.
